(19) United States
(12) Patent Application Publication
(10) Pub. No.: US 2011/0248569 A1
(43) Pub. Date: Oct. 13, 2011

(54) APPARATUS AND CONTROL METHOD OF MICRO-POWER SOURCE FOR MICROGRID APPLICATION

(75) Inventors: Kwang Myoung SON, Busan (KR); Kye Byung Lee, Busan (KR)

(73) Assignee: GRIDON INC., Busan (KR)

(21) Appl. No.: 12/902,566

(22) Filed: Oct. 12, 2010

(30) Foreign Application Priority Data
Apr. 9, 2010 (KR) 10-2010-0032972

(51) Int. Cl. H02J 3/08

(52) U.S. Cl. 307/87

(57) ABSTRACT

The present invention relates to a micro-power source for successfully implementing a microgrid and to a control method for realizing smooth reconnection between the microgrid and an upper electric power system and smooth switching between the control modes of the micro-power source. A micro-power source sectionalizes an electric power system into an upper electric power system and a lower electric power system, and enables the lower electric power system to be independently operated in an island mode and to smoothly switch between a grid-connected mode and the island mode. As a result, a hierarchical microgrid is implemented with sectionalized sub-microgrids. One of the merits of the hierarchical microgrid is that each consumer group can be supplied with high quality power regardless of the power quality of the other consumer groups, and various types of services independently.

### BACKGROUND OF THE INVENTION

1. Field of the Invention

The present invention relates, in general, to a micro-power source and a control method for the micro-power source, and, more particularly, to the construction and control method of a micro-power source for successfully implementing a microgrid and to a control method for realizing smooth reconnection between the microgrid and an upper electric power system, and smooth switching between the control modes of the micro-power source.

2. Description of the Related Art

Recently, various types of micro-power sources such as photovoltaics, fuel cells, micro turbines, energy storage devices, and diesel engine power generation have been frequently introduced to the electric power due to problems related to the location of power stations, investment in the construction of power transmission and distribution lines, environment, and etc.

Current regulation of utilities limits island operation of the micro-power sources mainly due to protection and safety problems. However, in order to provide consumers with premium power quality it is required to maintain the service of micro-power sources even in the case of the utility power system failure.

This motivates the development of microgrid which can be defined as a small-scale electric power system composed of various types of micro-power sources and consumers, and capable of performing island operation. Unlike uninterruptible power supply (UPS) systems supplying power when a power failure occurs for a short period of time, the microgrid can provide power continuously by using one or more micro-power sources. Consumers in the microgrid can not only be supplied with power with high reliability and quality, but also can be provided with various types of additional services.

FIG. 1A illustrates an example of the conventional construction of a microgrid in which a consumer group 106 including two micro-power sources 100 and 101 and loads (#1-4) 102, 103, 104, and 105 is connected to an upper electric power system 107 which is the electric power system of an electric power company through a interface (coupling) switch 108 and a transformer 109.

When a fault or the like occurs in the upper electric power system 107 of FIG. 1A, the consumers group 106 operated as a microgrid can disconnect the upper electric power system 107 therefrom and be independently operated by opening the interface switch 108, and thus the consumer group 106 may not undergo a power failure resulting from the upper electric power system 107. However, a neighboring consumer group 110 which is not operated as a microgrid in FIG. 1A will undergo a power failure due to the fault that occurred in the upper electric power system 107.

In FIG. 1A, the interface switch 108 includes sensors and control devices and monitors power quality by measuring the voltage and current of the upper electric power system 107. The interface switch 108 islands the microgrid from the upper power system if necessary, and reconnects the microgrid to the upper power system by detecting the synchronization condition of the voltages of the individual buses 111 and 112 at both ends of the interface switch 108 in FIG. 1A.

Further, in the microgrid, an integrated microgrid controller for managing and controlling the micro-power sources 100 and 101 and the interface switch 108 in an integrated manner may be provided. The integrated microgrid controller can control the output of the micro-power sources by communicating with the upper electric power system 107. The integrated microgrid controller can also receive notification of a planned power failure from the upper electric power system 107 and switch the microgrid to island operation, thus enabling the relevant consumer group 106 to be continuously supplied with high quality power.

FIG. 2 is a diagram showing two voltage sources 200 and 201, and an equivalent impedance 202 between the voltage sources 200 and 201.

In FIG. 2, active power and reactive power flowing between the two voltage sources 200 and 201 are represented by the following Equation (1) if the resistance of the impedance 202 can be neglected.

$$P = \frac{{V}_{1} {V}_{2}}{X} sin {δ}_{12} \\ Q = \frac{{V}_{1}^{2}}{X} - \frac{{V}_{1} {V}_{2}}{X} cos {δ}_{12} \qquad ( 1 )$$

In Equation (1), P is active power flowing between the two voltage sources, Q is reactive power flowing between the two voltage sources, V₁ and V₂ are voltage magnitudes (effective values) of the respective voltage sources (for example, V₁ is the voltage of a consumer group and V₂ is the voltage of the upper electric power system), δ₁₂ is a phase difference between the voltages of the voltage sources, that is, δ₁₂=δ₁−δ₂, δ₁ and δ₂ are the phases of the voltages of the respective voltage sources, and X is the inductance component of the equivalent impedance of the line, the synchronous reactance and the interface inductor.

If the phase difference between the voltages of the voltage sources, δ₁₂ is less than 30°, Equation (1) can be approximated to the following Equation (2).

$$P \approx \frac{{V}_{1} {V}_{2}}{X} {δ}_{12} \\ Q \approx \frac{{V}_{1}}{X} ( {V}_{1} - {V}_{2} ) \qquad ( 2 )$$

Equation (2) indicates that active power transferred between the two voltage sources can be controlled by the phase difference between the voltages of the two voltage sources and that reactive power transferred between the two voltage sources can be controlled by the magnitude difference between the voltages of the two voltage sources.

On the basis of Equation (2), the micro-power sources connected to an electric power system can control the active power thereof using the controller of FIG. 3, or can control the reactive power thereof using the controller of FIG. 4.

The controller of FIG. 3 inputs an error 302, which is a difference between a active power reference value 300 desired to be output from a micro-power source and active power 301 currently being output from the micro-power source, to a tracking control block 303, adds the output 304 of the control block 303 to the voltage phase 305 of the electric power system, and then determines the phase 306 of the output voltage of the micro-power source.

The controller of FIG. 4 inputs an error 402, which is a difference between a reactive power reference value 400 desired to be output from a micro-power source and reactive power 401 currently being output from the micro-power source, to a tracking control block 403, adds the output 404 of the control block 403 to the voltage magnitude 405 of the electric power system, and then determines the magnitude 406 of the output voltage of the micro-power source.

When a micro-power source is operated in island mode, the microgrid is disconnected from the upper electric power system 107 and the power demanded by the consumer group 106 must be supplied by all of the micro-power sources 100 and 101 in the microgrid. Therefore, the active and reactive power output of the micro-power sources cannot be actively controlled and are determined by the consumer demand and the losses, etc. Instead, micro-power sources must provide rated reference frequency and voltage requested by the relevant consumer group 106.

When the micro-power sources provide the rated reference frequency and voltage, the transient stability of the micro-power sources can be improved by using the characteristics of FIG. 5 indicating the droop characteristics of frequency and active power and FIG. 6 indicating the droop characteristics of voltage and reactive power.

Further, when the micro-power sources using droop characteristics as shown in FIGS. 5 and 6 are operated in an island mode, appropriate sharing of power is possible between the micro-power sources.

The droop characteristics of FIGS. 5 and 6 are represented by the following Equation (3).

ω(t)=ω₀−k_{P}_{ᵢ}(Pᵢ*−Pᵢ(t))

Vᵢ(t)=V₀−k_{Q}_{ᵢ}(Qᵢ*−Qᵢ(t)) (3)

In Equation (3), Pᵢ* and Qᵢ* are set-point values for active and reactive power of an i-th micro-power source, Pᵢ(t) and Qᵢ(t) are the outputs of the active power and the reactive power of the i-th micro-power source, is the rated frequency, V₀ is the rated voltage, ω(t) is the actual frequency of the voltage, Vᵢ(t) is the terminal voltage of the i-th micro-power source, kₚ is the proportional gain of the droop characteristics between the active power and the frequency (static droop gain), where kₚ<0, and k_{Q} is the proportional gain of the droop characteristics between the reactive power and the voltage, where k_{Q}<0, and i=1, 2, . . . , n, where n is the number of micro-power sources.

Each micro-power source operated in an island mode by Equation (3) can supply active power to the consumer group 106 using the controller of FIG. 7, and can also supply reactive power to the consumer group 106 using the controller of FIG. 8.

The controller of FIG. 7 determines frequency variation 703 by multiplying a difference between the preset active power set-point value 700 of the micro-power source and active power 701, which is currently being output from the micro-power source to supply power demanded by the consumer group 106, by the gain of a droop characteristic proportional gain (static droop gain) block 702. The frequency variation 703 is added to rated frequency 704, so that the frequency 705 of the output voltage of the micro-power source is determined. The frequency 705 of the output voltage of the micro-power source is integrated by an integrator 706, so that the phase 707 of the output voltage of the micro-power source is determined.

The controller of FIG. 8 determines voltage magnitude variation 803 by multiplying a difference between the preset reactive power set-point value 800 of the micro-power source and reactive power 801, which is currently being output from the micro-power source to supply power demanded by the consumer group 106, by the gain of a droop characteristic proportional gain block 802. The voltage magnitude variation 803 is added to the magnitude 804 of rated voltage, so that the magnitude 805 of the output voltage of the micro-power source is determined.

For the reliable and stable operation of a microgrid it is important for the controller of micro-power sources to support both grid-connected and island operation.

Since the frequencies of the voltage and current in the steady state are equal in the overall electric power system, the droop characteristic curves 500 and 501 of FIG. 5 enable the respective micro-power sources to output the preset active power set-points (Pᵢ*) 503 and 504 at the rated frequency 502.

On the basis of these frequency characteristics, the controller of FIG. 7 may be used as the active power controller of the micro-power sources for both grid-connected and island operation.

In the voltage control, however, the terminal voltages of the micro-power sources are different each other and do not become the rated voltage due to the local characteristics of the voltage, that is, steady state voltages do not appear equally in the overall electric power system.

Usually, output control satisfying reactive power set-point (Qᵢ*) 601 at the rated voltage 600 is required in grid-connected operation while providing the reference of voltage are required in island operation.

Therefore, in order to enable both grid-connected and island operation, both the controller of FIG. 4 for controlling reactive power in the grid-connected operation and the controller of FIG. 8 for the island operation are required.

Thus, the controller of FIG. 4 and the controller of FIG. 8 are combined with each other in the controller of FIG. 9 for supporting both the grid-connected and island operation.

The operation mode of the micro-power source should be determined for the appropriate switching of the selection switch 900 of FIG. 9 to a required controller.

Next, conventional control methods for reconnecting a micro-power source operated island mode to an upper electric power system 107 will be described.

In order for a microgrid 106 operated in an island mode to be reconnected to the upper electric power system 107, an appropriate resynchronization control is required to enable the phase and magnitude of the voltage of the microgrid 106 to be synchronized with the phase and magnitude of the voltage of the upper electric power system 107.

Reconnection of the microgrid 106 to the upper electric power system 107 without appropriate synchronization causes severe transients, which may activate protection devices or may give stress to various devices.

As described above, when the micro-power source is operated in an island mode, the frequency and voltage of the microgrid are different from the frequency and voltage of the upper electric power system 107 due to the droop characteristics of FIGS. 7 and 9.

When the microgrid 106 is operated in an island mode using the controller of FIG. 7 with lower frequency than that of the upper electric power system 107, a difference between the phases of the voltages at both ends of the interface switch 108 varies in a range from 0 to 360° due to the frequency difference between the upper electric power system 107 and the microgrid 106. Therefore, two independent voltage nodes can be connected to each other using a method of closing the interface switch 108 at the time when the difference between the voltages at both ends of the interface switch 108 is minimized.

However, in this method, the phases of the voltages are identical to each other, but the magnitudes of the voltages are not identical to each other at the time point at which the interface switch 108 is closed, and thus transients may occur due to the difference between the voltage magnitudes.

As another method, when a micro-power source capable of measuring information about the phases and magnitudes of the voltages at both ends of the interface switch 108 is present in the relevant consumer group 106, the micro-power source can synchronize the voltage of the consumer group 106 with the voltage of the upper electric power system 107 using the controllers of FIGS. 10 and 11.

The controller of FIG. 10 calculates a difference 1002 between the phases of the voltages at both ends of the interface switch 108 from the voltage phase 1000 of the relevant consumer group 106 and the voltage phase 1001 of the upper electric power system 107, inputs the phase difference 1002 to a control block 1003, and inputs the output 1004 of the control block 1003 as frequency variation 708 for synchronization of FIG. 7, thus realizing synchronization.

The controller of FIG. 11 similar to the voltage phase synchronization controller of FIG. 10 can synchronize the magnitudes of the voltages at both ends of the interface switch 108.

The controller of FIG. 11 calculates a difference 1102 between the magnitudes of the voltages at both ends of the interface switch 108 from the voltage magnitude 1100 of the relevant consumer group 106 and the voltage magnitude 1101 of the upper electric power system 107, inputs the magnitude difference 1102 to a control block 1103, and inputs the output 1104 of the control block 1103 as voltage variation 902 for synchronization of FIG. 8, thus realizing synchronization.

However, in this method, a micro-power source capable of fast communication with the controller of the interface switch 108 is required. Low reliability for fast communication does not guarantee the performance of such a synchronization function.

### SUMMARY OF THE INVENTION

The first condition required for the implementation of a microgrid is that when the microgrid is switched to island operation, micro-power sources in the microgrid must be able to immediately cope with the island operation. That is, micro-power sources 100 and 101 present in the microgrid must be able to immediately change the operation mode.

Switching to island mode in the conventional microgrid has been determined in such a way that the interface switch 108 located between the upper electric power system 107 and the microgrid 106 monitors the voltage quality of the upper electric power system 107. Therefore, fast communication is required between the interface switch 108 and the micro-power sources.

However, fast communication cannot guarantee the preferable implementation of a microgrid due to the problem of reliability. Since the micro-power source cannot immediately determine the operation mode of the microgrid without performing fast communication, the conventional micro-power source uses the controllers of FIGS. 7 and 8 which exploit droop characteristics regardless of the operation mode of the microgrid so as to provide references for frequency and voltage in the island operation. However, the micro-power source using the controller of FIG. 8 cannot control reactive power and merely controls voltage using droop characteristics in a grid-connected operation. The control of voltages by distributed energy resources in the grid-connected operation is restricted by the electric power company at the present time.

Therefore, in order to implement a preferable microgrid, a first technical problem to be solved by the present invention is to allow the micro-power sources 100 and 101 to immediately determine the operation mode of the microgrid without performing fast communication with the interface switch 108, to control active power and reactive power in a grid-connected operation, and provide rated reference frequency and voltage in an island operation.

The second condition required for the implementation of a microgrid is that when the upper electric power system 107 returns back to normal operating condition during island operation of the microgrid, the microgrid must be reconnected to the upper electric power system 107 using an appropriate synchronization method. However, most conventional micro-power sources are geographically located away from the interface switch 108, so that it is impossible to measure the voltage of the upper electric power system without fast communication, thus to synchronize the voltage of the microgrid with the voltage of the upper electric power system 107, fast communication is required, and the preferable implementation of the microgrid cannot be guaranteed due to the problem of reliability for fast communication.

Therefore, in order to preferably implement a microgrid, a second problem to be solved by the present invention is to allow the micro-power sources 100 and 101 to synchronize the voltage of the microgrid with the voltage of the upper electric power system 107 without performing fast communication with the interface switch 108, and smoothly reconnect the microgrid to the upper electric power system 107 after the completion of synchronization.

In FIG. 1A, if a micro-power source #3 120 is present in a load #1 102 as FIG. 1B, and another microgrid may be configured by means of the micro-power source #3 120 and an interface switch 121, this microgrid becomes a lower-layer microgrid, and thus the microgrids of FIG. 1B can be operated as a hierarchical structure. In this case, an upper-layer microgrid may be disconnected from the upper electric power system and is independently operated in island mode, but the lower-layer microgrid may be operated in connection with the upper-layer microgrid, so that micro-power sources in the lower-layer microgrid may need voltage control for improving voltage quality.

The last problem to be solved by the present invention is to smoothly switch two control modes for controlling active and reactive power and controlling rated reference frequency and voltage even in the case where a lower-layer microgrid is operated in connection with the upper-layer microgrid.

Accordingly, the present invention has been made considering the above problems occurring in the prior art, and the object of the present invention is to provide the construction and control structure of a micro-power source and methods of controlling the active and reactive power of the micro-power source which can improve power quality.

Another object of the present invention is to provide a control method for the micro-power source, which enables the smooth reconnection of a microgrid to an upper electric power system, and a control method, which can smoothly switch the control modes of the micro-power source when the micro-power source is in a grid-connected operation.

In order for a micro-power source according to the present invention to immediately determine the operation mode of a microgrid and provide appropriate control mode corresponding to each operation mode of the microgrid without performing communication with a interface switch, the interface switch is integrated with the micro-power source, and the controller of FIG. 9 is improved, so that a control method depending on the operation mode of the microgrid is used. The interface switch integrated with the micro-power source according to the present invention is controlled by a micro-power source control device without performing communication.

Since the micro-power source according to the present invention includes the interface switch, it does not require fast communication, and thus can synchronize the voltage of the microgrid with the voltage of an upper electric power system. Further, since the micro-power source control device directly controls the interface switch, smooth reconnection between the microgrid and the upper electric power system can be performed. Furthermore, the improved controller of FIG. 9 based on the control method for the micro-power source according to the present invention feeds the output of a deactivated control block forward to the output of a control block which is activated after reconnection, thus causing the output voltage reference value of the micro-power source to continue at the time point of reconnection. As a result, it is possible for the microgrid to more rapidly reach a steady state, thus contributing to the smooth reconnection of the microgrid.

The improved controller of FIG. 9 based on the control method for the micro-power source according to the present invention can smoothly switch two control modes, that is, mode for controlling active and reactive power and mode for controlling rated reference frequency and voltage, even when a lower-layer microgrid is operated in connection with the upper-layer microgrid in a hierarchical microgrid structure.

As an example in accordance with an aspect of the present invention, there is provided a micro-power source for sectionalizing an electric power system into an upper electric power system and a lower electric power system, and enabling the lower electric power system to be independently operated in an island mode and to smoothly switch between a grid-connected mode and the island mode, the micro-power source comprising: a first interface switch connected between a third bus connected to an upper electric power system and a second bus connected to a lower electric power system; a second interface switch connected between a first internal bus and the second bus; an inverter for converting a Direct Current (DC) voltage from a DC power source into an Alternating Current (AC) voltage; and a micro-power source control device for measuring voltages of the first bus, the second bus and the third bus, measuring currents of the first interface switch and the second interface switch, and generating signals required to control opening/closing of the first interface switch and the second interface switch and a signal required to control an output voltage of the inverter.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a diagram showing the construction of a conventional microgrid;

FIG. 1B is a diagram showing possible construction of a hierarchical microgrid;

FIG. 2 is a diagram showing the active and reactive power flowing between two voltage sources;

FIG. 3 is a diagram showing the construction of the active power controller of a conventional micro-power source;

FIG. 4 is a diagram showing the construction of the reactive power controller of the conventional micro-power source;

FIG. 5 is a diagram showing the droop characteristics of frequency and active power;

FIG. 6 is a diagram showing the droop characteristics of voltage and reactive power;

FIG. 7 is a diagram showing the construction of the active power controller of a conventional micro-power source based on the droop characteristics of frequency and active power;

FIG. 8 is a diagram showing the construction of the reactive power controller of a conventional micro-power source based on the droop characteristics of voltage and reactive power;

FIG. 9 is a diagram showing the construction of the reactive power controller of a conventional micro-power source enabling both an island and a grid-connected operation;

FIG. 10 is a diagram showing the construction of the voltage phase synchronization controller of the conventional micro-power source;

FIG. 11 is a diagram showing the construction of the voltage magnitude synchronization controller of the conventional micro-power source;

FIG. 12A is a diagram showing the construction and control structure of a micro-power source and the construction of a microgrid implemented using the micro-power source according to an embodiment of the present invention;

FIG. 12B is a diagram showing a typical electric power system;

FIG. 12C is a diagram showing the construction of a hierarchical microgrid structure composed of micro-power sources according to an embodiment of the present invention;

FIG. 13 is a diagram showing the construction of the active power controller of a micro-power source according to an embodiment of the present invention;

FIG. 14 is a diagram showing the reactive power controller of the micro-power source according to an embodiment of the present invention;

FIG. 15 is a diagram showing the construction of the voltage phase synchronization controller of the micro-power source according to an embodiment of the present invention; and

FIG. 16 is a diagram showing the voltage magnitude synchronization controller of the micro-power source according to an embodiment of the present invention.

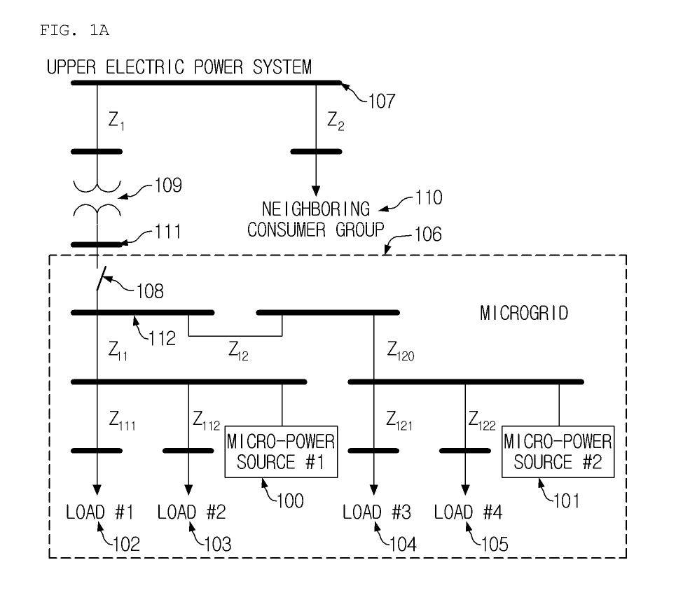

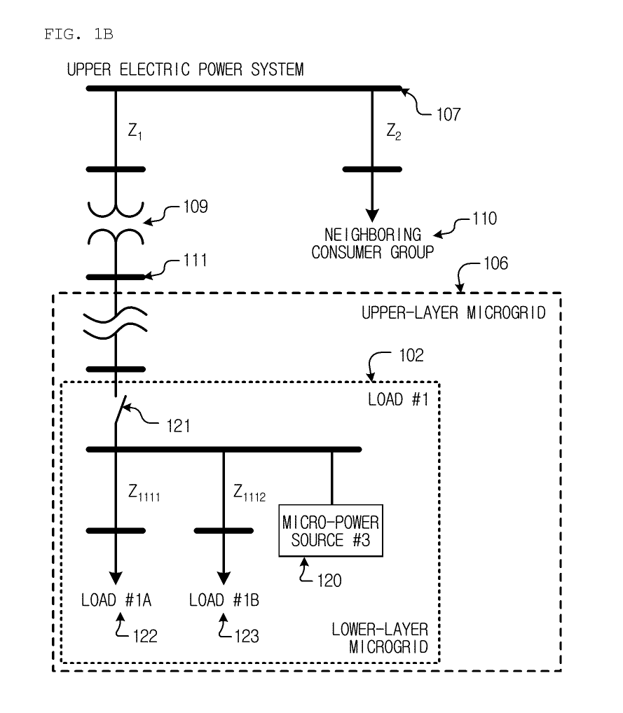

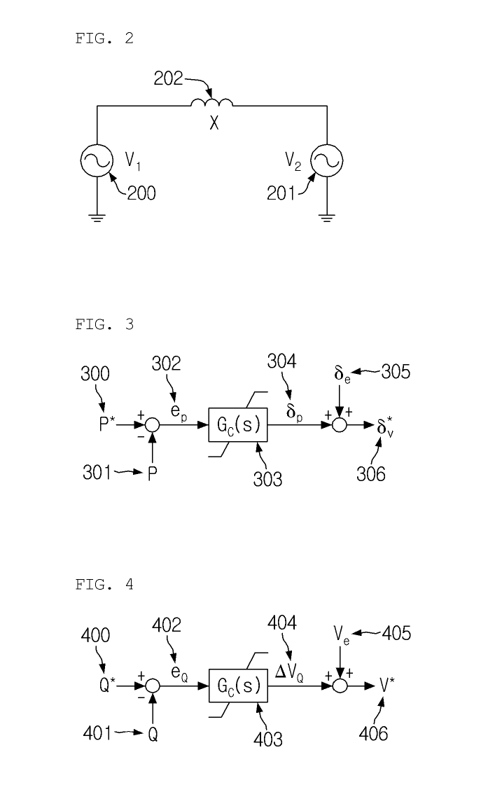

### DESCRIPTION OF THE PREFERRED EMBODIMENTS

Hereinafter, embodiments of the present invention will be described in detail with reference to the attached drawings. However, the present invention is not limited or restricted to those embodiments.

Reference now should be made to the drawings, in which the same reference numerals are used throughout the different drawings to designate the same or similar components.

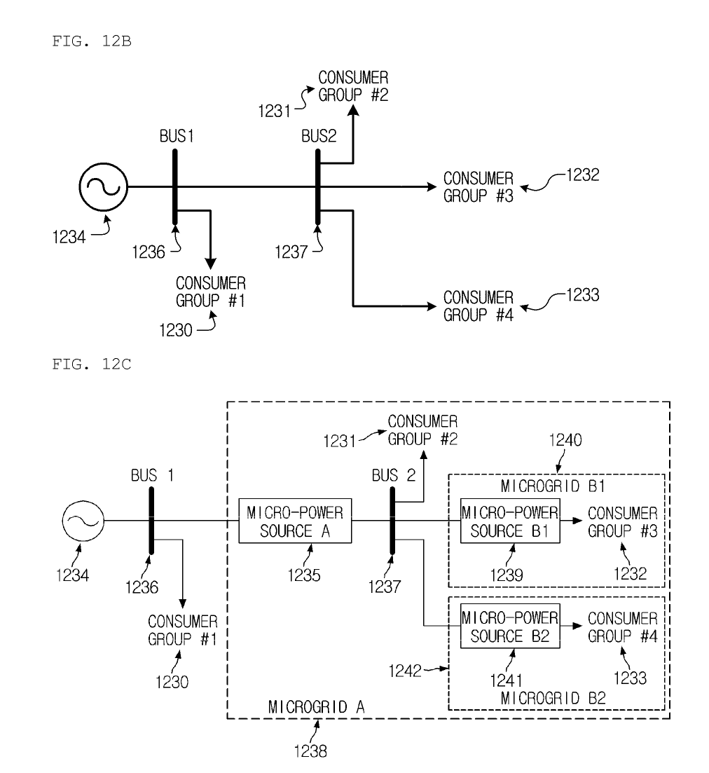

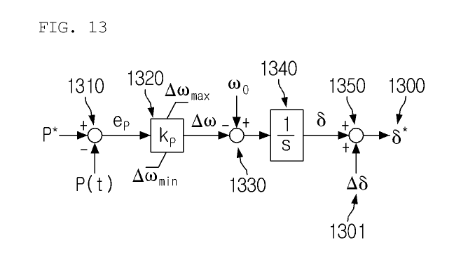

FIG. 12A is a diagram showing the construction of a microgrid 1201 implemented using a micro-power source 1200 according to an embodiment of the present invention.

Referring to FIG. 12A, the microgrid 1201 according to an embodiment of the present invention includes the micro-power source 1200 and the remainder 1202 of the microgrid 1201. The micro-power source 1200 includes a third bus 1205 connected to an upper electric power system 1204 via a transformer 1203, a first interface switch (Interface Switch: IS) 1212, a second bus 1206 connected to the third bus 1205 via the IS 1212, a second interface switch (Connection Switch: CS) 1211, and a first bus 1210 connected to the second bus 1206 via the CS 1211. In addition, the micro-power source 1200 includes a DC power source 1207, an inverter 1208, an integrated microgrid control device 1213, and a micro-power source control device 1214. The remainder 1202 of the microgrid may include loads of a consumer group in which the operation of the microgrid is implemented, and may also include various types of micro-power sources if necessary. A relevant consumer group may be supplied with demanded power from the micro-power source 1200 and the upper electric power system 1204 via the second bus 1206, or may supply the remaining power to the micro-power source 1200 and the upper electric power system 1204 on the contrary. The transformer 1203 may not be included depending on the voltage magnitudes of the upper electric power system 1204 and the consumer group.

As shown in FIG. 12A, the integrated microgrid control device 1213 can exchange control signals required for the operation of the microgrid with the upper electric power system 1204 and the remainder 1202 of the microgrid by bidirectional communication, and can control both the micro-power source 1200 and the remainder 1202 of the microgrid in an integrated manner. Further, the micro-power source control device 1214 can generate signals S_{IS}* and S_{CS}* required to control the opening/closing of the respective interface switches 1211 and 1212 by measuring voltages V₁, V₂, and V₃ of the respective buses 1210, 1206 and 1205 and currents I_{M} and I_{U} flowing through the respective interface switches 1211 and 1212, and can generate a reference value (V*) 1216 (including an output voltage phase reference value) required to control the output voltage of the inverter 1208.

The DC power source 1207 of the micro-power source 1200 may be one of a variety of DC power sources provided by power generation systems which use various types of power generation technologies such as photovoltaics, hydrogen/fuel cells, hydrogen fuel cells, bio-energy (biodiesel, bioethanol, biogas, Biomass-to-Liquid: BtL), ocean energy (using tidal power generation, tidal current power generation, wave power generation, and sea water temperature difference), wind power generation, terrestrial heat, water power generation, and wastes. Further, the DC power source 1207 may include an energy storage device for guaranteeing a fast response, and may also include a DC-DC converter for converting a DC voltage, or electrical control devices or power sources for various types of power conversion, if necessary.

The inverter 1208 of the micro-power source 1200 converts the DC voltage from the DC power source 1207 into an AC voltage having predetermined magnitude and phase required for a consumer group. In this case, the inverter 1208 may output an AC voltage, the magnitude and phase of which track those of the output voltage reference value (V*) 1216 (including an output voltage phase reference value) output from the micro-power source control device 1214. The inverter 1208 may include a filter for eliminating harmonic components or a transformer.

The micro-power source control device 1214 measures the voltages V₁, V₂ and V₃ of the respective buses 1210, 1206, and 1205, and measures currents I_{M} and I_{U} of the respective interface switches 1211 and 1212, thus performing power control for the operation of the microgrid. The micro-power source control device 1214 can determine the reference value (V*) 1216 required to control the output voltage of the inverter 1208 (including the output voltage phase reference value) using the voltage and current signals (V₁, V₂, V₃, I_{M} and I_{U}) 1215 which are directly measured without performing communication. Further, the micro-power source control device 1214 determines whether to open or close the CS 1211 and the IS 1212 which are the interface switches by checking whether synchronization has been completed on the basis of the measured voltages signals V₁, V₂, and V₃, thus setting the respective switching signals (S_{IS}* and S_{CS}*) 1217 and 1218 for the CS 1211 and the IS 1212.

The integrated microgrid control device 1213 of the micro-power source 1200 may control or monitor other micro-power sources and loads present in the remainder 1202 of the microgrid while performing bidirectional communication 1219 with them. Further, the integrated microgrid control device 1213 may perform higher control than the micro-power source control device 1214, and may change references, set-points, etc. for the power and voltage of the micro-power source control device 1214. Furthermore, the integrated microgrid control device 1213 may perform bidirectional communication 1220 with the specific control device of the upper electric power system 1204 so as to optimally operate both the micro-power source 1200 and the remainder 1202 of the microgrid.

Such a micro-power source 1200 accurately determines the time point at which operation mode is switched to island mode because of the voltage sag occurring for a short period of time due to an accident or the like on the upper electric power system 1204, a power failure occurring for a long period of time, and the deterioration of power quality, thereby preferably minimizing transients occurring at the time of switching to island operation, and realizing various control modes depending on the operation mode. That is, preferably, the micro-power source 1200 can control reactive power in grid-connected operation, and can perform voltage control using droop characteristics so as to provide references for frequency and voltage in island operation.

Further, the micro-power source 1200 can directly measure the phase and magnitude of the voltage of the upper electric power system 1204 without performing fast communication. Accordingly, the micro-power source 1200 can preferably synchronize the voltage V₂ of the microgrid with the voltage V₃ of the upper electric power system 1204, and can also minimize transients in the stage of reconnecting to the upper electric power system 1204.

Furthermore, since the micro-power source 1200 is present at the location at which the microgrid 1201 is connected to the upper electric power system 1204, it functions to interface the two electric networks 1201 and 1204 with each other (functions as a grid-interfacing unit or a gateway). In addition, the micro-power source 1200 may be inserted into any part of the conventional radial electric power distribution system, so that partition it into an upper electric power system and a lower electric power system, enabling the lower system to be independently operated in an island mode and to smoothly switch between a grid-connected and the island mode. By the micro-power source 1200, the lower electric power system can be supplied with power with high reliability and quality and various types of services as in the microgrid 1201.

FIG. 12C illustrates the structure of an electric power system in which micro-power sources 1200 of the present invention are inserted into a typical electric power system as FIG. 12B and hierarchical microgrid with sub-microgrids 1238/1240/1242 are implemented according to an embodiment of the present invention.

In FIG. 12C, consumer groups (#1 to #4) 1230, 1231, 1232, and 1233, each may include a plurality of micro-power sources and a plurality of loads, may be supplied with power from an equivalent power source 1234 in which a plurality of lines, power generators, transformers, etc. present in the electric power system are represented, or may supply the remaining power to the utility power system equivalently represented as a power source 1234.

In FIG. 12C, a micro-power source A 1235, a micro-power source B1 1239, and a micro-power source B2 1241 may have a structure of the micro-power source 1200 of FIG. 12A. FIG. 12C illustrates an example in which the micro-power source A 1235 disposed between a bus #1 1236 and a bus #2 1237 constitute a microgrid A 1238 for the consumer groups #2 to #4 1231, 1232 and 1233. In FIG. 12C, the micro-power source B1 1239 is disposed between the bus #2 1237 and a consumer group #3 1232 to constitute a lower-layer microgrid B1 1240 for the consumer group #3 1232, and the micro-power source B2 1241 is disposed between the bus 1237 and the consumer group #4 1233 to constitute another lower-layer microgrid B2 1242 for the consumer group #4 1233. One of the merits of the constitution of such sectionalized microgrids is that each consumer group can be supplied with high quality power regardless of the power quality of the other consumer groups, and various types of services independently.

The construction and control structure of the micro-power source 1200 of FIG. 12A is not a technology limited to a microgrid. That is, the micro-power source 1200 may also be used for a power supply device, which can be operated both in connection with and independently of the grid so that supply power satisfying high quality and various types of services to loads located close to the loads.

Next, a method of controlling the active power and reactive power of the micro-power source 1200 which can improve power quality in the construction of the micro-power source 1200 is described.

FIG. 13 illustrates an active power controller provided in the micro-power source control device 1214 of the micro-power source 1200 according to an embodiment of the present invention.

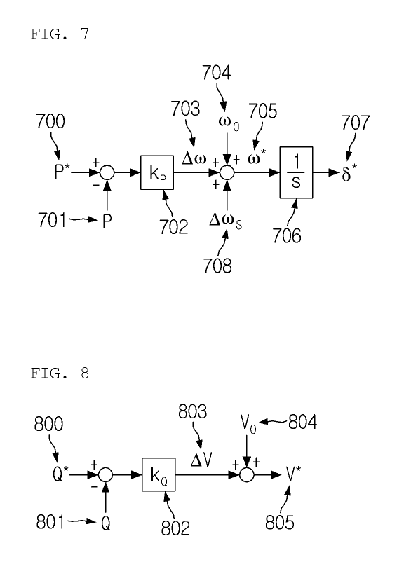

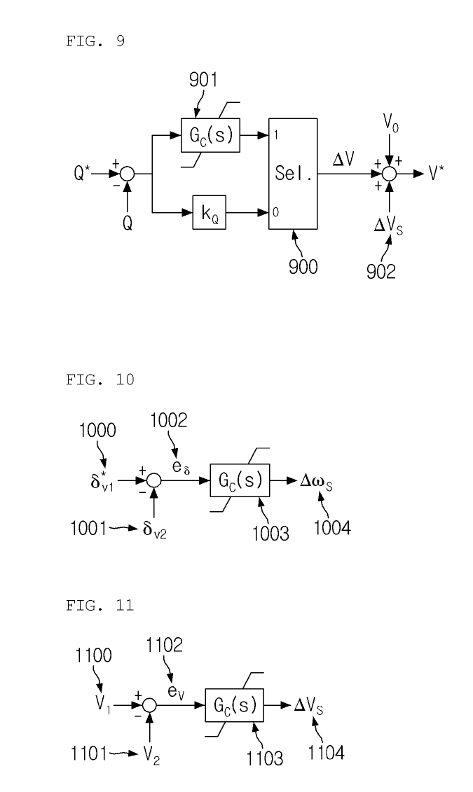

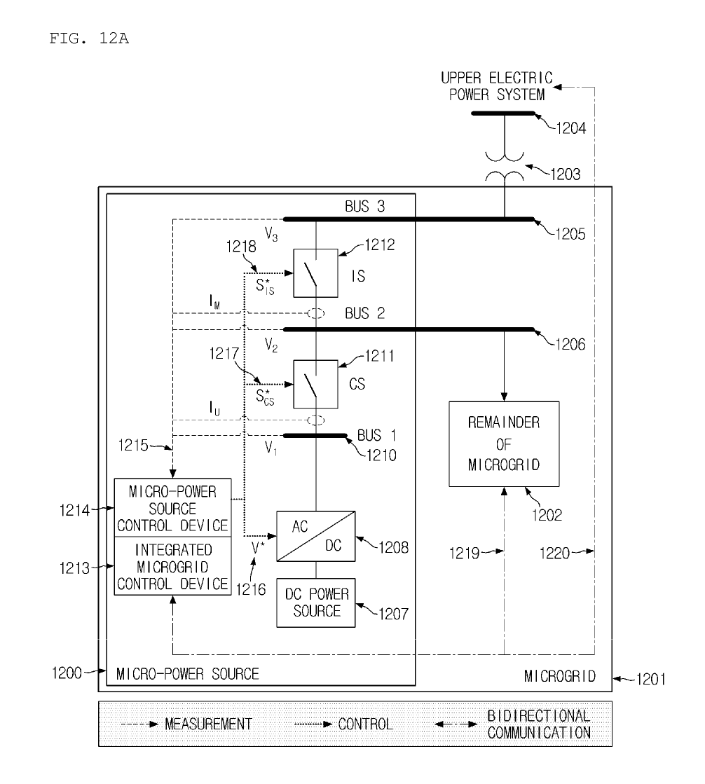

In FIG. 13, the active power controller according to an embodiment of the present invention includes a first subtractor 1310, a proportional gain block 1320, a second subtractor 1330, an integrator 1340, and an adder 1350. Here, instead of the frequency variation 708 for synchronization in the controller of FIG. 7, voltage phase variation (Δδ) 1301 for synchronization is added, and thus an output voltage phase reference value 1300 is determined.

The active power controller obtains a difference e_{P} between a preset active power set-point P* and active power P(t), which is currently being output through the first bus 1210 to supply power required by loads, using the first subtractor 1310. Further, the active power controller determines a frequency variation Δω by multiplying this error e_{P} by the proportional gain kₚ of the droop characteristics between the active power and the frequency using the proportional gain block 1320. The active power controller subtracts the frequency variation Δω from the rated frequency ωₒ by using the second subtractor 1330, thus determining the frequency (ωₒ−Δω) of the output voltage of the micro-power source. The frequency (ωₒ−Δω) of the output voltage of the micro-power source is integrated by the integrator 1340, and an integration result value is added to voltage phase variation (Δδ) 1301 for synchronization using the adder 1350. As a result, the output voltage phase reference value (δ*) 1300 of the micro-power source (corresponding to the voltage phase component 1216 in FIG. 12A) can be determined.

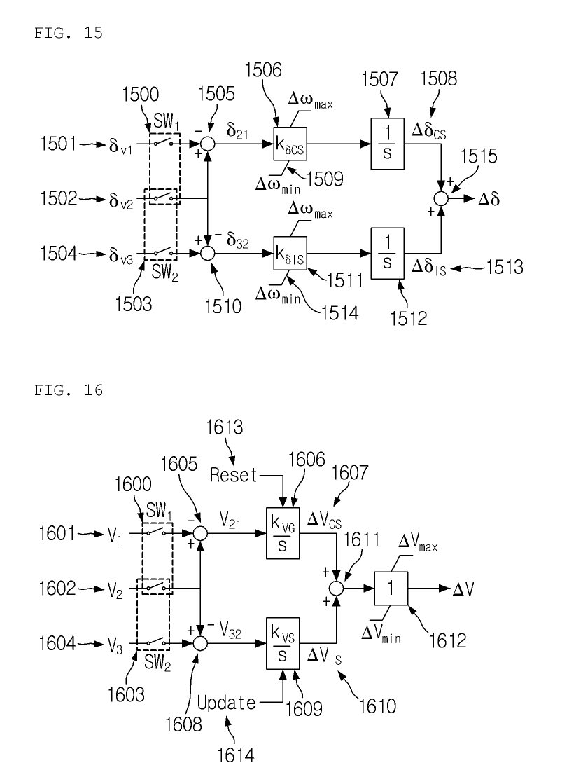

As the voltage phase variation (Δδ) 1301 for synchronization, which is input to the active power controller of FIG. 13, voltage phase variation (Δδ) determined by the voltage phase synchronization controller of FIG. 15 is input, and can be output at the time point at which synchronization control is required.

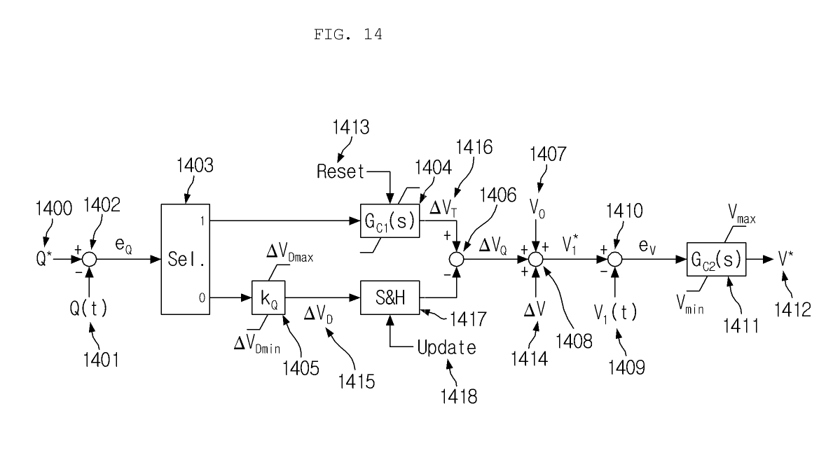

FIG. 14 is a diagram showing a reactive power controller provided in the micro-power source control device 1214 of the micro-power source 1200 according to an embodiment of the present invention.

In FIG. 14, the reactive power controller according to an embodiment of the present invention has a form in which reactive power tracking control mode executed in a grid-connected operation, and droop characteristic voltage control mode executed in an island operation are combined with each other.

Referring to FIG. 14, the reactive power controller according to the embodiment of the present invention includes a first subtractor 1402, a selection switch 1403, a reactive power tracking control block 1404, a proportional gain block 1405, a Sample and Hold (S & H) block 1417, a second subtractor 1406, an adder 1408, a third subtractor 1410, and a voltage magnitude tracking control block 1411.

The reactive power controller obtains a difference e_{Q} between the preset reactive power set-point 1400 of the micro-power source and reactive power 1401, which is currently being output from the micro-power source through the first bus 1210, using the first subtractor 1402. Such a reactive power error e_{Q} can be input to the selection switch 1403.

The selection switch 1403 can input the reactive power error e_{Q} to the reactive power tracking control block 1404 so as to track and control reactive power when the operation mode of the microgrid 1201 is grid-connected operation, and can input the reactive power error e_{Q} to the proportional gain block 1405 for droop characteristic voltage control so as to control voltage using droop characteristics when the operation mode of the microgrid 1201 is island operation.

According to circumstances, even if the operation mode of the microgrid 1201 is grid-connected operation, the selection switch 1403 can input the reactive power error e_{Q} to the proportional gain block 1405 required for droop characteristic voltage control so as to control the voltage using droop characteristics, and can also input the reactive power error e_{Q} to the reactive power tracking control block 1404 so as to track and control the reactive power.

The reactive power tracking control block 1404 generates voltage magnitude variation (ΔV_{T}) 1416 required to track and control reactive power on the basis of the reactive power error e_{Q}. The proportional gain block 1405 generates voltage magnitude variation (ΔV_{D}) 1415 required for the control of a droop characteristic voltage magnitude using by multiplying the reactive power error e_{Q} by the proportional gain k_{Q} of the droop characteristics between the reactive power and the voltage. The S & H block 1417 samples and outputs the voltage magnitude variation (ΔV_{D}) 1415 required for the control of the droop characteristic voltage magnitude.

Accordingly, the second subtractor 1406 subtracts the voltage magnitude variation (ΔV_{D}) 1415 required for the control of the droop characteristic voltage magnitude, which has been sampled by the S & H block 1417, from the voltage magnitude variation (ΔV_{T}) 1416 required to track and control reactive power, thereby determining the voltage magnitude variation (ΔV_{Q}) of the reactive power controller.

The adder 1408 outputs a voltage magnitude reference value V₁* for the first bus 1210 of the micro-power source 1200 by adding up the voltage magnitude variation (ΔV_{Q}) output from the second subtractor 1406, the rated voltage magnitude (V₀) 1407 and the voltage magnitude variation (ΔV) 1414 for synchronization.

Further, the third subtractor 1410 outputs a voltage magnitude error eᵥ which is a difference between the voltage magnitude reference value (V₁*) for the first bus 1210 of the micro-power source 1200 and the current voltage magnitude (V₁(t)) 1409 of the first bus 1210. The voltage magnitude error eᵥ is input to the voltage magnitude tracking control block 1411 for the first bus 1210.

The voltage magnitude tracking control block 1411 for the first bus 1210 determines the output voltage magnitude reference value (V*) 1412 (corresponding to the voltage magnitude component 1216 in FIG. 12A) required to track and control the voltage magnitude of the first bus 1210 based on the voltage magnitude error (e_{V}).

In FIG. 14, the reset function 1413 of the reactive power tracking control block 1404 can be activated during a period from the time point at which the selection switch 1403 switches from the reactive power tracking control block 1404 to the droop characteristic proportional gain block 1405 to the time point immediately before the selection switch 1403 selects again the reactive power tracking control block 1404. In particular, in the case where the reset function 1413 of the reactive power tracking control block 1404 is activated in the controller of FIG. 14 when the selection switch 1403 switches from the reactive power tracking control block 1404 to the droop characteristic proportional gain block 1405, the results of the reactive power tracking control block 1404 do not influence the droop characteristic voltage control, thus enabling more accurate droop characteristic voltage control to be performed.

As the voltage magnitude variation (ΔV) 1414 for synchronization, which is input to the reactive power controller of FIG. 14, the voltage magnitude variation (ΔV) determined by the voltage magnitude synchronization controller of FIG. 16 is input. This voltage magnitude variation (ΔV) can be output at the time point at which the control of synchronization is required.

Hereinafter, a method of determining voltage phase variation (Δδ) which will be input as the voltage phase variation (Δδ) 1301 of the active power controller of FIG. 13 and a method of determining voltage magnitude variation (ΔV) which will be input as the voltage magnitude variation (ΔV) 1414 of the reactive power controller of FIG. 14 will be described in detail with reference to FIG. 15 and FIG. 16, respectively.

The micro-power source 1200 uses a voltage control method (grid-forming control) of outputting an independent voltage regardless of the voltage of an electric power system (grid), rather than a current control-based dependent voltage control method (grid-following control) of outputting relative voltage on the basis of the voltage of the electric power system. Accordingly, the control of synchronization of individual independent voltages is required so as to preferably minimize transients at the time of making connection before closing the CS 1211 as well as closing the IS 1212.

FIG. 15 is a diagram showing a voltage phase synchronization controller for determining voltage phase variation (Δδ) which will be input as the voltage phase variation (Δδ) 1301 of the active power controller provided in the micro-power source control device 1214 of the micro-power source 1200 according to an embodiment of the present invention.

Referring to FIG. 15, the voltage phase synchronization controller according to the embodiment of the present invention includes a voltage phase synchronization controller for the CS 1211, a voltage phase synchronization controller for the IS 1212, and an adder 1515. The voltage phase synchronization controller for the CS 1211 includes a signal input switch (SW₁) 1500, a subtractor 1505, a synchronization gain block 1506, and an integrator 1507. When the signal input switch (SW₁) 1500 is closed, the voltage phase 1501 of the first bus 1210 is synchronized with the voltage phase 1502 of the second bus 1206. The voltage phase synchronization controller for the IS 1212 includes a signal input switch (SW₂) 1503, a subtractor 1510, a synchronization gain block 1511, and an integrator 1512. When the signal input switch (SW₂) 1503 is closed, the voltage phase 1502 of the second bus 1206 is synchronized with the voltage phase 1504 of the third bus 1205.

In the voltage phase synchronization controller for the CS 1211, the subtractor 1505 calculates a voltage phase error δ₂₁ which is a difference between the voltage phase 1502 of the second bus 1206 and the voltage phase 1501 of the first bus 1210. The synchronization gain block 1506 multiples the voltage phase error δ₂₁ by a synchronization gain k_{δCS}, so that a multiplication result value is integrated by the integrator 1507, and thus voltage phase variation (Δδ_{CS}) 1508 for the synchronization of voltage phase of the CS 1211 is determined. In the voltage phase synchronization controller for the CS 1211, the frequency of the output of the synchronization gain block 1506 can be limited to fall within a predetermined threshold range from Δωₘᵢₙ to Δωₘₐₓ by a hard limiter 1509 during the control of synchronization by the micro-power source 1200 so that the frequency of the voltage output from the micro-power source 1200 can be maintained at a level close to the rated frequency.

In the voltage phase synchronization controller for the IS 1212, the subtractor 1510 calculates a voltage phase error δ₃₂ which is a difference between the voltage phase 1504 of the third bus 1205 and the voltage phase 1502 of the second bus 1206. The synchronization gain block 1511 multiples the voltage phase error δ₃₂ by a synchronization gain k_{δIS}, and the integrator 1512 integrates a multiplication result value, so that voltage phase variation (Δδ_{IS}) 1513 for the synchronization of the voltage phase of the IS 1212 is determined. In the voltage phase synchronization controller for the IS 1212, the frequency of the output of the synchronization gain block 1511 can be limited to fall within a predetermined threshold range from Δωₘᵢₙ to Δωₘₐₓ by a hard limiter 1514 during the control of synchronization by the micro-power source 1200 so that the frequency of the voltage output from the micro-power source 1200 can be maintained at a level close to the rated frequency.

Accordingly, the adder 1515 adds the voltage phase variation (Δδ_{CS}) 1508 of the voltage phase synchronization controller of the CS 1211 to the voltage phase variation (Δδ_{IS}) 1513 of the voltage phase synchronization controller of the IS 1212, thus determining the voltage phase variation (Δδ) of the synchronization controller of the micro-power source 1200. The voltage phase variation (Δδ) can be input as the voltage phase variation (Δδ) 1301 of FIG. 13.

FIG. 16 is a diagram showing a voltage magnitude synchronization controller for determining voltage magnitude variation (ΔV) which will be input as the voltage magnitude variation (ΔV) 1414 of the reactive power controller provided in the micro-power source control device 1214 of the micro-power source 1200 according to an embodiment of the present invention.

Referring to FIG. 16, the voltage magnitude synchronization controller according to the embodiment of the present invention includes a voltage magnitude synchronization controller for the CS 1211, a voltage magnitude synchronization controller for the IS 1212, an adder 1611 and a hard limiter 1612. The voltage magnitude synchronization controller for the CS 1211 includes a signal input switch (SW₁) 1600, a subtractor 1605, and an integral controller 1606, and synchronizes the voltage magnitude 1601 of the first bus 1210 with the voltage magnitude 1602 of the second bus 1206 when the signal input switch (SW₁) 1600 is closed. The voltage magnitude synchronization controller for the IS 1212 includes a signal input switch (SW₂) 1603, a subtractor 1608, and an integral controller 1609, and synchronizes the voltage magnitude 1502 of the second bus 1206 with the voltage magnitude 1504 of the third bus 1205 when the signal input switch (SW₂) 1603 is closed.

In the voltage magnitude synchronization controller for the CS 1211, the subtractor 1605 calculates a voltage magnitude error V₂₁ which is a difference between the voltage magnitude 1602 of the second bus 1206 and the voltage magnitude 1601 of the first bus 1210. The integral controller 1606 determines voltage magnitude variation (ΔV_{CS}) 1607 for the synchronization of the voltage magnitude of the CS 1211 on the basis of the voltage magnitude error V₂₁.

In the voltage magnitude synchronization controller for the IS 1212, the subtractor 1608 calculates a voltage magnitude error V₃₂ which is a difference between the voltage magnitude 1604 of the third bus 1205 and the voltage magnitude 1602 of the second bus 1206. The integral controller 1609 determines voltage magnitude variation (ΔV_{IS}) 1610 for the synchronization of the voltage magnitude of the IS 1212 on the basis of the voltage magnitude error V₃₂.

Accordingly, the adder 1611 adds the voltage magnitude variation (ΔV_{CS}) 1607 of the voltage magnitude synchronization controller for the CS 1211 to the voltage magnitude variation (ΔV_{IS}) 1610 of the voltage magnitude synchronization controller for the IS 1212, thus determining the voltage magnitude variation (ΔV) of the synchronization controller of the micro-power source 1200. The voltage magnitude variation (ΔV) can be input as the voltage magnitude variation (ΔV) 1414 of FIG. 14. Here, in the voltage magnitude synchronization controller, the voltage magnitude of the output (ΔV) of the adder 1611 can be limited to fall within a predetermined threshold range from ΔVₘᵢₙ to ΔVₘₐₓ by the hard limiter 1612 during the control of synchronization by the micro-power source 1200 so that the magnitude of the voltage output from the micro-power source 1200 can be maintained at a level close to the rated voltage magnitude.

The reset function 1613 of the integral controller 1606 in the voltage magnitude synchronization controller of FIG. 16 can be activated during a period from the time point at which the CS 1211 is opened to the time point immediately before the two switches of the signal input switch (SW₁) 1600 are closed so as to activate the voltage magnitude synchronization controller for the CS 1211.

Similarly, the reset function 1614 of the integral controller 1609 in the voltage magnitude synchronization controller of FIG. 16 can be activated during a period from the time point at which the IS 1212 is opened to the time point immediately before two switches of the signal input switch (SW₂) 1603 are closed so as to activate the voltage magnitude synchronization controller for the IS 1212.

Prior to describing the control method for the micro-power source 1200, enabling the smooth reconnection between the microgrid 1201 and the upper electric power system 1204 among the objects of the present invention, an embodiment of the reconnection between the microgrid 1201 and the upper electric power system 1204 via the micro-power source 1200 will be primarily described.

The active power controller of the micro-power source 1200 presented in FIG. 13 can be operated without considering the operation mode of the microgrid 1201 (grid-connected or island operation).

However, the reactive power controller of the micro-power source 1200 presented in FIG. 14 must select the selection switch 1403 as any one of reactive power tracking control and droop characteristic voltage control in consideration of the operation mode of the microgrid 1201 (grid-connected or island operation).

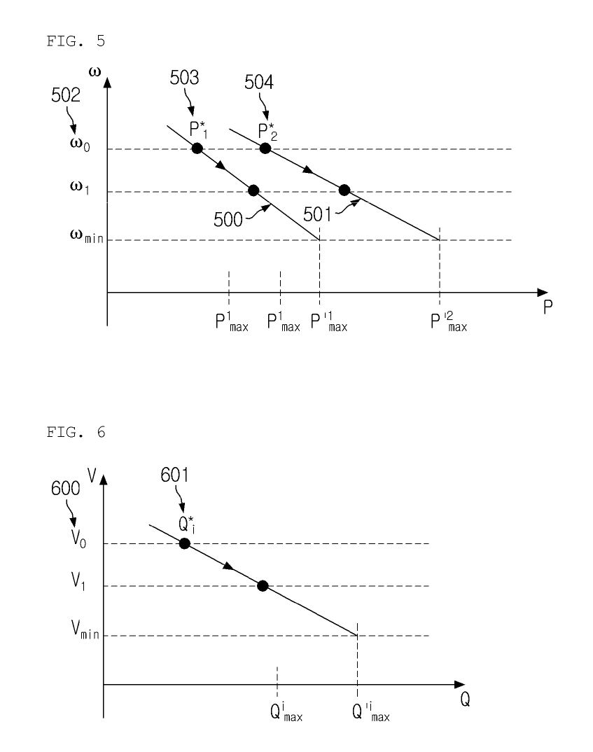

When the microgrid 1201 is in island operation, it can be operated at a voltage magnitude less than or greater than the rated voltage magnitude (V_{O}) 1407 by voltage magnitude variation (ΔV_{D}) 1415 determined by the droop characteristics of FIG. 6.

Under this operation condition, in order for the microgrid 1201 to be reconnected to the upper electric power system (grid), both the voltage phase synchronization controller (FIG. 15) and the voltage magnitude synchronization controller (FIG. 16) of the micro-power source 1200 for synchronizing the voltages at both ends of the IS 1212 must be activated prior to such reconnection. When the synchronization controllers (in FIG. 15 and FIG. 16) are activated, the synchronization of the voltages at both ends of the IS 1212 can be completed when performing control while the voltage phase variation (Δδ) and the voltage magnitude variation (ΔV) are respectively input as the voltage phase variation (Δδ) 1301 of the active power controller (FIG. 13) of the micro-power source 1200 and the voltage magnitude variation (ΔV) 1414 of the reactive power controller (FIG. 14).

When the synchronization of the voltages at both ends of the IS 1212 has been completed, the micro-power source 1200 closes the IS 1212 to reconnect the microgrid 1201 to the upper electric power system 1204, and allows the selection switch 1403 of FIG. 14 to select reactive power tracking control from droop characteristic voltage control, thus controlling reactive power.

In the embodiment of the reconnection between the microgrid 1201 and the upper electric power system 1204, the voltage magnitude reference value (V₁*) for the first bus 1210, output from the adder 1408 when the synchronization of the voltages at both ends of the IS 1212 is completed before reconnection is made, is given by the following Equation (4), and the voltage magnitude reference value (V₁*) for the first bus 1210 of the micro-power source 1200 after reconnection has been made is given by the following Equation (5),

V₁*=V₀+ΔV_{D}+V_{T}+ΔV (4)

V₁*=V₀+ΔV_{T}+ΔV (5)

where V₁* in Equations (4) and (5) denotes the voltage magnitude reference value for the first bus 1210 of the micro-power source 1200, V₀ denotes the magnitude 1407 of the rated voltage, ΔV_{D} denotes the voltage magnitude variation 1415 determined by droop characteristics, ΔV_{T} denotes the voltage magnitude variation 1416 determined by the tracking control of reactive power, and ΔV denotes the voltage magnitude variation of the voltage magnitude synchronization controller of FIG. 16.

On the basis of Equations (4) and (5), it can be seen that before and after reconnection has been made, the voltage magnitude reference value V₁* for the first bus 1210 of the micro-power source 1200 is discontinuously changing.

This discontinuity of the voltage magnitude reference value V₁* for the first bus 1210 may cause severe transients when the microgrid 1201 and the upper electric power system 1204 are reconnected to each other by closing the IS 1212. The transient may interfere with the tracking control of reactive power, but a method enabling smooth reconnection is proposed as follows.

Hereinafter, a control method for the micro-power source 1200 enabling smooth reconnection between the microgrid 1201 and the upper electric power system 1204 among the objects of the present invention will be described.

In the reactive power controller of FIG. 14, the S & H block 1417 performs the procedures of:

(a) sampling the voltage magnitude variation (ΔV_{D}) 1415 determined by droop characteristics,

(b) being capable of updating and outputting the sampled value of the voltage magnitude variation (ΔV_{D}) 1415 determined by droop characteristics, and

(c) feeding the output of the S & H block 1417 forward to the subtractor 1406 so that the output is subtracted from the reactive power tracking control output determined by the reactive power tracking control block 1404, that is, the voltage magnitude variation (ΔV_{T}) 1416.

In particular, the S & H block 1417 samples the voltage magnitude variation (ΔV_{D}) 1415 determined by droop characteristics every predetermined sampling step in procedure (a). Further, in procedure (b), when the microgrid 1201 is operated in island mode and the micro-power source 1200 is performing voltage control using droop characteristics before the microgrid 1201 is switched to the grid-connected operation, the output of the S & H block 1417 can be updated (1418) to the voltage magnitude variation (ΔV_{D}) 1415 sampled in procedure (a), and the updated results can be output. Further, in procedure (c), when the microgrid 1201 is switched to grid-connected operation mode and is in the grid-connected operation, and the micro-power source 1200 is tracking and controlling the reactive power, the S & H block 1417 feeds the voltage magnitude variation (ΔV_{D}) 1415 updated in procedure (b) forward to the reactive power tracking control output ΔV_{T} 1416. Accordingly, the subtractor 1406 can subtract the updated output (ΔV_{D}) 1415 of the S & H block 1417 from the voltage magnitude variation (ΔV_{T}) 1416 for reactive power tracking control.

In other words, in the reactive power controller of FIG. 14, the voltage V₂ of the microgrid 1201 being in island operation (for example, voltage at the second bus) is synchronized with the voltage V₁ of the upper electric power system 1204, and the microgrid 1201 and the upper electric power system 1204 are reconnected to each other. Thereafter, the S & H block 1417 holds the voltage magnitude variation (ΔV_{D}) 1415, determined by droop characteristics and sampled before reconnection has been made, while the micro-power source 1200 is tracking and controlling reactive power using the voltage magnitude variation (ΔV_{D}) 1415. Accordingly, the voltage magnitude variation (ΔV_{D}) 1415 is fed forward to the reactive power tracking control output 1416, and thus the subtractor 1406 can subtract the output (ΔV_{D}) 1415, which has been updated and held by the S & H block 1417, from the voltage magnitude variation (ΔV_{T}) 1416 for reactive power tracking control.

That is, in the reactive power controller of FIG. 14, the S & H block 1417 stores the voltage magnitude variation (ΔV_{D}) 1415 determined by droop characteristics before the micro-power source 1200 switches control mode to reactive power tracking control mode, and feeds the voltage magnitude variation (ΔV_{D}) 1415 determined by droop characteristics forward to the voltage magnitude variation (ΔV_{T}) 1416 via reactive power tracking control after the micro-power source 1200 switches control mode to reactive power tracking control mode, thus guaranteeing faster control performance for reactive power tracking control. This results in the improvement of reliability and power quality, and in the improvement of performance and the service life of various devices provided in the remainder 1202 of the microgrid, as well as the micro-power source 1200.

Next, prior to describing a control method enabling the control mode of the micro-power source 1200 to be smoothly switched even during a grid-connected operation among the objects of the present invention, a possible embodiment of the operation of the micro-power source 1200 will be primarily described.

The micro-power source 1200 tracks and controls reactive power when the microgrid 1201 is in grid-connected operation, and controls voltage using droop characteristics when the microgrid 1201 is in island operation. However, in an embodiment which will be described later, when the microgrid 1201 is in the grid-connected operation, the micro-power source 1200 does not need to track and control the reactive power.

The tracking control of the reactive power is a current control-based dependent voltage control method (grid-following control) of outputting relative voltage on the basis of the voltage of the electric power system, and cannot guarantee power quality that is as excellent as droop characteristic voltage control which is a voltage control method (grid-forming control) of outputting independent voltage regardless of the voltage of the electric power system.

A hierarchical microgrid structure can be implemented using the micro-power source 1200. That is, a lower-layer microgrid is connected to an upper-layer microgrid, but the upper-layer microgrid functioning as an upper electric power system for the lower-layer microgrid can be disconnected from the upper electric power system and can be operated in island mode. Accordingly, the lower-layer microgrid is capable of performing voltage control restricted by the electric power company. That is, when the micro-power source 1200 is provided in the lower-layer microgrid, droop characteristic voltage control is possible even though the microgrid is in grid-connected operation. This result means that when the microgrid is in the grid-connected operation, the micro-power source 1200 must be able to switch individual control modes for reactive power tracking control and for droop characteristic voltage control according to the circumstances. In addition, even in the case where the upper electric power system allows voltage control, the micro-power source 1200 must also be able to switch individual control modes (for reactive power tracking control and for droop characteristic voltage control in FIG. 14) according to the circumstances when the microgrid is in grid-connected operation.

Hereinafter, in consideration of these contents, a control method capable of smoothly switching individual control modes of the micro-power source 1200 (for reactive power tracking control and for droop characteristic voltage control in FIG. 14) even during the grid-connected operation, among the objects of the present invention, is presented.

Similarly to the control method for the micro-power source 1200 which enables smooth reconnection between the microgrid 1201 and the upper electric power system 1204, the control method capable of smoothly switching the control modes of the micro-power source 1200 is intended to solve the discontinuity of the voltage magnitude reference value V₁* for the first bus 1210 output from the adder 1408 of the micro-power source 1200 so that the discontinuously changing of the voltage magnitude reference value V₁* can be converted into continuously changing thereof. Therefore, the control method capable of smoothly switching the control modes of the micro-power source 1200 can be performed by controlling the selection switch 1403 so that, of procedures (a), (b), and (c) performed by the S & H block 1417 of FIG. 14 which is the reactive power controller of the micro-power source 1200 according to the embodiment of the present invention, procedures (b) and (c) are performed regardless of the operation mode of the microgrid 1201.

As described above, according to the micro-power source for the microgrid of the present invention, a micro-power source playing an important role to implement microgrid technology in an electric power system can accurately determine the time point at which the operation mode of the microgrid should be switched to island operation because of the voltage sag occurring for a short period of time due to an accident in an upper electric power system, a power failure occurring for a long period of time, and the deterioration of power quality. The determination of the time point at which the operation mode of the micro-power source is switched to the island operation enables the micro-power source to have various types of control modes depending on the respective operation modes of the microgrid. Accordingly, the micro-power source can control active power and reactive power in a grid-connected operation, and can provide rated reference frequency and voltage in an island operation.

Further, the micro-power source for the microgrid and control method for the micro-power source according to the present invention is advantageous in that even if the controller parameters of the micro-power source are not precisely tuned, smooth reconnection between the microgrid and an upper electric power system becomes possible. Furthermore, such a control method can smoothly switch control modes between the control of reactive power and voltage control using droop characteristics, thus enabling the droop characteristic voltage control to be performed if necessary even in the grid-connected operation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should not be limited to the above-described embodiments, and should be defined by the accompanying claims and equivalents thereof.

What is claimed is:

1. A micro-power source for sectionalizing an electric power system into an upper electric power system and a lower electric power system, and enabling the lower electric power system to be independently operated in an island mode and to smoothly switch between a grid-connected mode and the island mode, the micro-power source comprising:
a first interface switch connected between a third bus connected to an upper electric power system and a second bus connected to a lower electric power system;
a second interface switch connected between a first internal bus and the second bus;
an inverter for converting a Direct Current (DC) voltage from a DC power source into an Alternating Current (AC) voltage; and
a micro-power source control device for measuring voltages of the first bus, the second bus and the third bus, measuring currents of the first interface switch and the second interface switch, and generating signals required to control opening/closing of the first interface switch and the second interface switch and a signal required to control an output voltage of the inverter.

2. The micro-power source according to claim 1, wherein the micro-power source control device directly controls the first interface switch and the second interface switch without communicating with the first interface switch and the second interface switch.

3. The micro-power source according to claim 1, wherein the micro-power source control device comprises:
an active power controller for generating an output voltage phase reference value required to control phase of the output voltage of the inverter; and
a reactive power controller for generating an output voltage magnitude reference value required to control magnitude of the output voltage of the inverter.

4. The micro-power source according to claim 3, wherein the active power controller comprises:
a first subtractor for calculating a difference (e_{P}) between a preset active power set-point (P*) and active power (P(t)) currently being output through the first bus;
a proportional gain block for multiplying the difference (e_{P}) by a proportional gain (kₚ) of droop characteristics between active power and frequency, thus determining frequency variation (Δω);
a second subtractor for subtracting the frequency variation (Δω) from a rated frequency (ω₀), thus determining frequency (ω₀−Δω) of voltage of current output;
an integrator for integrating the frequency (ω₀−Δω) of the output voltage; and
an adder for adding an integration result value output from the integrator to voltage phase variation (Δδ), thus determining the output voltage phase reference value.

5. The micro-power source according to claim 3, wherein the reactive power controller comprises:
a first subtractor for calculating a difference (e_{Q}) between a preset reactive power set-point (Q*) and reactive power currently being output through the first bus;
a selection switch for selectively outputting the difference (e_{Q})) to a first path for tracking control of the reactive power or a second path for voltage control using droop characteristics;
a reactive power tracking control block for generating voltage magnitude variation (ΔV_{T}) determined to track and control the reactive power based on the difference (e_{Q}) in the first path;
a proportional gain block for generating a value, obtained by multiplying the difference (e_{Q}) by a proportional gain (k_{Q}) of droop characteristics between reactive power and voltage in the second path, as voltage magnitude variation (ΔV_{D}) determined for voltage control using droop characteristics;
a sample and hold block for sampling the voltage magnitude variation (ΔV_{D}), and outputting a sampled value;
a second subtractor for subtracting the sampled value from the voltage magnitude variation (ΔV_{T});
an adder for adding up output of the second subtractor, a magnitude of rated voltage, and voltage magnitude variation (ΔV);
a third subtractor for outputting a voltage magnitude error (e_{V}) which is a difference between an output of the adder and a voltage magnitude of current output; and
a voltage magnitude tracking control block for determining the output voltage magnitude reference value (V*) based on the voltage magnitude error (e_{V}).

6. The micro-power source according to claim 4, wherein:
the micro-power source control device further comprises a voltage phase synchronization controller for determining the voltage phase variation (Δδ), and
the voltage phase synchronization controller comprises:
a first voltage phase synchronization controller for synchronizing a voltage phase of the first bus with a voltage phase of the second bus;
a second voltage phase synchronization controller for synchronizing the voltage phase of the second bus with a voltage phase of the third bus; and
an adder for outputting a value, obtained by adding a voltage phase variation (Δδ_{CS}) determined by the first voltage phase synchronization controller to a voltage phase variation (Δδ_{IS}) determined by the second voltage phase synchronization controller, as the voltage phase variation (Δδ).

7. The micro-power source according to claim 6, wherein the first voltage phase synchronization controller comprises:
a first subtractor for calculating a voltage phase error (δ₂₁) which is a difference between the voltage phase of the second bus and voltage phase of the first bus;
a first synchronization gain block for multiplying the voltage phase error (δ₂₁) by a synchronization gain (k_{δCS}); and
a first integrator for integrating an output of the first synchronization gain block and outputting the voltage phase variation (Δδ_{CS}) required for synchronization of a voltage phase of the second interface switch, and
the second voltage phase synchronization controller comprises:
a second subtractor for calculating a voltage phase error (δ₃₂) which is a difference between the voltage phase of the third bus and voltage phase of the second bus;
a second synchronization gain block for multiplying the voltage phase error (δ₃₂) by a synchronization gain (k_{δIS}); and
a second integrator for integrating an output of the second synchronization gain block and outputting the voltage phase variation (Δδ_{IS}) required for synchronization of a voltage phase of the first interface switch.

8. The micro-power source according to claim 7, wherein a frequency of the output of the first synchronization gain block or the second synchronization gain block is limited to fall within a predetermined threshold range from Δωₘᵢₙ to Δωₘₐₓ by a hard limiter, thus maintaining the voltage frequency of the current output at a frequency close to a rated frequency.

9. The micro-power source according to claim 5, wherein:
the micro-power source control device further comprises a voltage magnitude synchronization controller for determining the voltage magnitude variation (ΔV), and
the voltage magnitude synchronization controller comprises:
a first voltage magnitude synchronization controller for synchronizing a voltage magnitude of the first bus with a voltage magnitude of the second bus;
a second voltage magnitude synchronization controller for synchronizing the voltage magnitude of the second bus with a voltage magnitude of the third bus; and
an adder for outputting a value, obtained by adding a voltage magnitude variation (ΔV_{CS}) determined by the first voltage magnitude synchronization controller to a voltage magnitude variation (ΔV_{IS}) determined by the second voltage magnitude synchronization controller, as the voltage magnitude variation (ΔV).

10. The micro-power source according to claim 9, wherein:
the first voltage magnitude synchronization controller comprises:
a first subtractor for calculating a voltage magnitude error (V₂₁) which is a difference between the voltage magnitude of the second bus and the voltage magnitude of the first bus; and
a first integral controller for determining the voltage magnitude variation (ΔV_{CS}) required for synchronization of a voltage magnitude of the second interface switch, based on the voltage magnitude error (V₂₁), and
the second voltage magnitude synchronization controller comprises:
a second subtractor for calculating a voltage magnitude error (V₃₂) which is a difference between the voltage magnitude of the third bus and voltage magnitude of the second bus; and
a second integral controller for determining voltage magnitude variation (ΔV_{IS}) required for synchronization of a voltage magnitude of the first interface switch, based on the voltage magnitude error (V₃₂).

11. The micro-power source according to claim 9, wherein a voltage magnitude of the output of the adder in the voltage magnitude synchronization controller is limited to fall within a predetermined threshold range from Δωₘᵢₙ, to Δωₘₐₓ by a hard limiter, thus maintaining the voltage magnitude of the current output at a level close to a rated voltage magnitude.

12. The micro-power source according to claim 5, wherein, in order to prevent occurrence of transient current of the first interface switch by preventing the voltage magnitude reference value (V₁*) for the first bus of the micro-power source from being discontinuous when the first interface switch is closed,
the reactive power controller stores the voltage magnitude variation (ΔV_{D}), determined by droop characteristics during an island operation, every predetermined sampling step using the sample and hold block, before control mode switches from island operation control mode to reactive power tracking control mode, and
the reactive power controller feeds the sampled value of the voltage magnitude variation (ΔV_{D}) forward to the voltage magnitude variation (ΔV_{T}) after the control mode has switched to the reactive power tracking control mode.

13. A control method for a micro-power source, the control method including a reactive power control method of generating an output voltage magnitude reference value required to control magnitude of an output voltage of a micro-power source which performs an island and a grid-connected operation, the method comprising:
when a selection switch for selecting individual control paths for reactive power tracking control and voltage control using droop characteristics switches a control mode from a voltage control mode path using droop characteristics to a reactive power tracking control mode path, in order to allow the reactive power tracking control to be rapidly performed and to smoothly switch a control mode of the micro-power source by preventing the voltage magnitude reference value (V₁*) for an output terminal of the micro-power source from being discontinuous,
a) storing voltage magnitude variation (ΔV_{D}), determined by droop characteristics, every predetermined sampling step using a sample and hold block; and
b) after switching the control mode from the voltage control mode using the droop characteristics to the reactive power tracking control mode, feeding a sampled value of the voltage magnitude variation (ΔV_{D}) forward to voltage magnitude variation (ΔV_{T}) determined in the reactive power tracking control mode.

14. An active power controller of a micro-power source control device, comprising:
a first subtractor for calculating a difference (e_{P}) between a preset active power set-point (P*) and active power (P(t)) currently being output;
a proportional gain block for multiplying the difference (e_{P}) by a proportional gain (kₚ) of droop characteristics between active power and frequency, thus determining frequency variation (Δω);
a second subtractor for subtracting the frequency variation (Δω) from a rated frequency (ω₀), thus determining frequency (ω₀−Δω) of the voltage of current output;
an integrator for integrating the frequency (ω₀−Δω) of the output voltage;
an adder for adding an integration result value output from the integrator to voltage phase variation (Δδ), thus determining the output voltage phase reference value; and
a voltage phase synchronization controller for determining the voltage phase variation (Δδ).

15. The active power controller according to claim 14, wherein the voltage phase synchronization controller comprises:
a first voltage phase synchronization controller for synchronizing voltage phase of the first bus with voltage phase of a second bus;
a second voltage phase synchronization controller for synchronizing the voltage phase of the second bus with voltage phase of a third bus; and
an adder for outputting a value, obtained by adding voltage phase variation (Δδ_{CS}) determined by the first voltage phase synchronization controller to voltage phase variation (Δδ_{IS}) determined by the second voltage phase synchronization controller, as the voltage phase variation (Δδ).

16. The active power controller according to claim 15, wherein the first voltage phase synchronization controller comprises:
a first subtractor for calculating a voltage phase error (δ₂₁) which is a difference between voltage phase of the second bus and voltage phase of the first bus;
a first synchronization gain block for multiplying the voltage phase error (δ₂₁) by a synchronization gain (k_{δCS}); and
a first integrator for integrating an output of the first synchronization gain block and outputting the voltage phase variation (Δδ_{CS}) required for synchronization of voltage phase of the second interface switch, and
the second voltage phase synchronization controller comprises:
a second subtractor for calculating a voltage phase error (δ₃₂) which is a difference between voltage phase of the third bus and the voltage phase of the second bus;
a second synchronization gain block for multiplying the voltage phase error (δ₃₂) by a synchronization gain (k_{δIS}); and
a second integrator for integrating an output of the second synchronization gain block and outputting the voltage phase variation (Δδ_{IS}) required for synchronization of voltage phase of the first interface switch.

17. A reactive power controller of a micro-power source control device, comprising:
a first subtractor for calculating a difference (e_{Q}) between a preset reactive power set-point (Q*) and reactive power currently being output;
a selection switch for selectively outputting the difference (e_{Q})) to a first path for tracking control of the reactive power or a second path for voltage control using droop characteristics;
a reactive power tracking control block for generating voltage magnitude variation (ΔV_{T}) determined to track and control the reactive power based on the difference (e_{Q}) in the first path;
a proportional gain block for generating a value, obtained by multiplying the difference (e_{Q}) by a proportional gain (k_{Q}) of droop characteristics between reactive power and voltage in the second path, as voltage magnitude variation (ΔV_{D}) determined for voltage control using droop characteristics;
a sample and hold block for sampling the voltage magnitude variation (ΔV_{D}), and outputting a sampled value;
a second subtractor for subtracting the sampled value from the voltage magnitude variation (ΔV_{T});
an adder for adding up output of the second subtractor, a magnitude of rated voltage, and voltage magnitude variation (ΔV);
a third subtractor for outputting a voltage magnitude error (e_{V}) which is a difference between an output of the first adder and a voltage magnitude of current output;
a voltage magnitude tracking control block for determining the output voltage magnitude reference value (V*) based on the voltage magnitude error (e_{V}); and
a voltage magnitude synchronization controller for determining the voltage magnitude variation (ΔV).

18. The reactive power controller according to claim 17, wherein the voltage magnitude synchronization controller comprises:
a first voltage magnitude synchronization controller for synchronizing a voltage magnitude of the first bus with a voltage magnitude of a second bus;
a second voltage magnitude synchronization controller for synchronizing the voltage magnitude of the second bus with a voltage magnitude of a third bus; and
an adder for outputting a value, obtained by adding voltage magnitude variation (ΔV_{CS}) determined by the first voltage magnitude synchronization controller to voltage magnitude variation (ΔV_{IS}) determined by the second voltage magnitude synchronization controller, as the voltage magnitude variation (ΔV).

19. The reactive power controller according to claim 18, wherein:
the first voltage magnitude synchronization controller comprises:
a first subtractor for calculating a voltage magnitude error (V₂₁) which is a difference between the voltage magnitude of the second bus and the voltage magnitude of the first bus; and
a first integral controller for determining voltage magnitude variation (ΔV_{CS}) required for synchronization of a voltage magnitude of the second interface switch, based on the voltage magnitude error (V₂₁), and
the second voltage magnitude synchronization controller comprises:
a second subtractor for calculating a voltage magnitude error (V₃₂) which is a difference between the voltage magnitude of the third bus and the voltage magnitude of the second bus; and
a second integral controller for determining voltage magnitude variation (ΔV_{IS}) required for synchronization of a voltage magnitude of the first interface switch, based on the voltage magnitude error (V₃₂).
